(19) United States
(12) Patent Application Publication
(10) Pub. No.: US 2010/0086735 A1
(43) Pub. Date: Apr. 8, 2010

(54) Patterned Functionalization of Nanomechanical Resonators for Chemical Sensing

(75) Inventors: Jeffrey W. Baldwin, Fairfax Station, VA (US); Maxim K. Zalalutdinov, Silver Spring, MD (US); Bradford B. Pate, Arlington, VA (US); Brian H. Houston, Fairfax, VA (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(73) Assignee: The United States of America as represented by the Secretary of the Navy

(21) Appl. No.: 12/571,830

(22) Filed: Oct. 1, 2009

Related U.S. Application Data
(60) Provisional application No. 61/102,470, filed on Oct. 3, 2008.

(51) Int. Cl. B32B 3/10; B05D 3/06

(52) U.S. Cl. 428/138; 427/551; 427/553

(57) ABSTRACT

A method of functionalizing a nanomechanical resonator involving providing a wafer with a thin film layer on a sacrificial layer, suspending freely a resonator on the wafer, coating the resonator with a liquid containing a terminal allyl group, placing a quartz-mask on the wafer, trapping the liquid between the mask and the wafer, initiating a reaction of the terminal allyl with photo-induced electrons, rinsing the wafer, and drying the wafer. The liquid can be 2-allyl hexafluoroisopropanol or another liquid that has an effective sorbent group for DMMP or DNT. The initiating can be performed via a deep UV source selected from a Hg arc, Xe arc, or DUV laser. The method can further include incorporating narrow gaps of from about 50 to about 300 nm in the resonator.

Nanomechanical resonators with their extremely small mass and high surface/volume ratio present a unique opportunity for mass sensing. However, functionalization of nanomechanical resonators with selective vapor adsorptive functional groups has been an impediment to the realization of nanomechanical systems for mass sensing.

Functional groups that adsorb analytes of interest should be patterned only on the nanoresonator itself, and should not be located on structural elements or micro-channel walls, which greatly limits the minimum detectable limit of the overall device. Also, traditional spin cast polymer films present the problem of being many times thicker than the nanomechanical resonator, essentially burying the resonator in the adsorptive polymer and completely damping the resonator.

To address these shortcomings, the present disclosure describes using a generic monolayer functionalization scheme based on a UV-mediated reaction between terminal alkenes and a hydrogen terminated silicon or diamond surface.

Specifically, disclosed herein is the selective surface functionalization with a vapor adsorptive monolayer of hexafluoro-dimethylcarbinol on diamond and silicon nanomechanical resonators.

Thick films incorporating the hexafluoro-dimethylcarbinol group have already been shown in SAW devices to be an effective sorbent polymer for dimethyl methylphosphonate (DMMP), a surrogate of the nerve agent Sarin.

In addition, disclosed herein is the use of in-plane vibratory modes, coupled with sub-wavelength gaps, of diamond and silicon nanomechanical resonators for enhanced sensitivity and use in air.

The device is based on the fusion of a deep UV functionalization technique, a knowledge of polymer adsorption, and a specifically designed nanomechanical resonator for mass sensing.

Various methods to gain detection specificity with nanomechanical resonators include spin-casting, ink-jet printing, and dip-pen nanolithography. Spin cast films can be used on SAW devices and thick microelectromechanical systems (MEMS), but due to the extremely small device layers in nanomechanical resonators (NEMS), spin cast films typically destroy a released resonator. Ink-jet printing and dip-pen nanolithography give high spatial resolution, but the thickness of the film is difficult to control, and these techniques are also too slow.

By combining deep-UV functionalization with a knowledge of polymer/monomer adsorption, a molecule can be produced that can be directly attached to a NEMS resonator using an optical mask. Optical printing of the attached molecule can be performed over large wafers, with the entire wafer being exposed at the same time, thus multiple parallel devices can be functionalized at once.

Another benefit of this technique over spin casting is that the molecule is only attached to the surface where it was exposed to the deep UV radiation, thus adding the simplicity of optical patterning without additional steps.

Still another benefit to this UV mediated photochemistry is that the molecule is actually covalently bonded to the resonator, which means that a strong bond has been formed, which is robust and resistant to degradation due to repeated cycling, which is not the case in these other methods.

Research shows that in-plane vibrations are less sensitive to air damping than out-of-plane modes, which is why the geometry to in-plane resonators is specified, e.g. tuning fork.

Further studies have shown that sub-wavelength gaps increase the responsivity, and thus the minimum detectable motion, by almost ten times.

The high sensitivity of NEMS resonators allows for high sensitivity while the polymer choice and deposition technique allows for chemical selectivity.

This disclosure provides a method to construct an inexpensive and extremely sensitive mass sensor with chemical specificity. Specific adsorbates include, but are not limited to, explosives and chemical weapons.

### BRIEF DESCRIPTION OF THE DRAWINGS

FIG. 1 illustrates a SEM micrograph of a nanocrystalline diamond resonator with sub-wavelength slit for detection of in-plane vibratory modes.

FIG. 2 illustrates an optical setup for test and measurement of nanomechanical resonators.

FIG. 3 illustrates the in-plane modes of vibration show markedly increased quality factors (1000:1) from out-of-plane modes at atmospheric pressure.

FIG. 4 illustrates the increased sensitivity of in-plane modes with narrow, sub-wavelength gaps.

FIG. 5 illustrates a functionalization scheme to covalently bond a sorptive polymer to a nanomechanical resonator (silicon or diamond).

FIG. 6 illustrates the response of a functionalized nanomechanical resonator (single crystal diamond dome) in a flow cell upon exposure and purge to an organic base, triethylamine, at a concentration of 70%₀_{_{V}} with a flow rate of 700 ml/min.

FIG. 7 is a SEM micrograph of released polysilicon nanomechanical dome resonator with heavily doped polysilicon thermoelastic actuator.

FIG. 8 illustrates measured pressure dependence (points) of first vibratory mode (47 MHz) from vacuum to atmospheric pressure with a theoretical estimate computed and plotted (trace).

FIG. 9 illustrates a reaction scheme for H-terminated silicon selective functionalization with 2-allyl hexafluoroisopropanol using a deep UV mask.

FIG. 10 is an XPS spectra of the functionalized silicon. XPS spectra (Si-2p, F-1s, and C-1s) for functionalized silicon surface.

One embodiment disclosed herein involves a method of functionalizing a nanomechanical resonator comprising providing a wafer with a thin film layer on a sacrificial layer, suspending freely a resonator on the wafer, coating the resonator with a liquid containing a terminal allyl group, placing a quartz-mask on the wafer, trapping the liquid between the mask and the wafer, initiating a reaction of the terminal allyl with photo-induced electrons, rinsing the wafer, and drying the wafer. The method can further include incorporating narrow gaps of from about 50 to about 300 nm in the resonator.

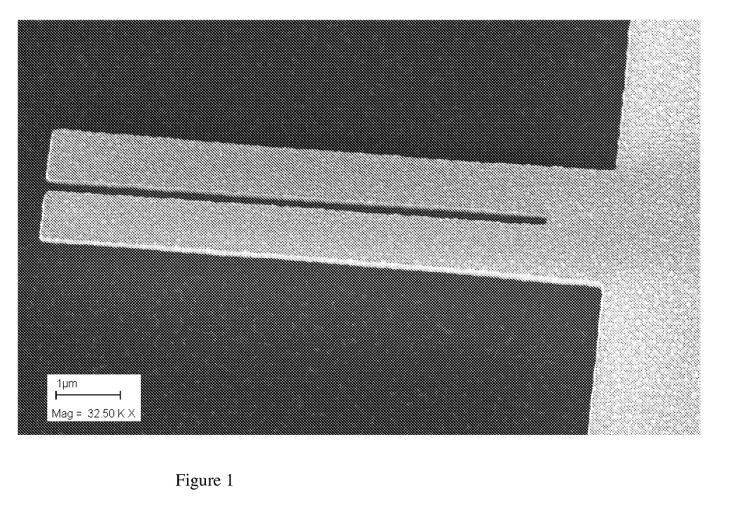

A SEM micrograph of the proposed device is shown in FIG. 1. The device is a harmonic oscillator with a given mass and frequency of vibration. Any added mass, such as from adsorption of an explosive molecule or chemical agent, would shift the frequency and be detected.

The device can be constructed from nanocrystalline diamond films grown on a sacrificial layer (such as silicon dioxide), or other materials as well such as silicon, single crystal diamond, polycrystalline diamond, polycrystalline silicon, silicon nitride, silicon oxide, and silicon carbide. Standard lithography techniques are implemented to form a free-standing resonator, for example a tuning fork, dome, cantilever, doubly clamped beam, or plate. Incorporation of a narrow, sub-wavelength gap is an important element to the design of an ultra-high sensitivity chemical sensor.

Functionalization of the nanomechanical resonator is also an important element, since the functional groups on the surface of the nanomechanical resonator will dictate what molecules the surface will adsorb. The functionalization must also be robust, and covalently bonded to the resonator to allow repeated use and thermal cycling of adsorbed species.

### EXAMPLE 1

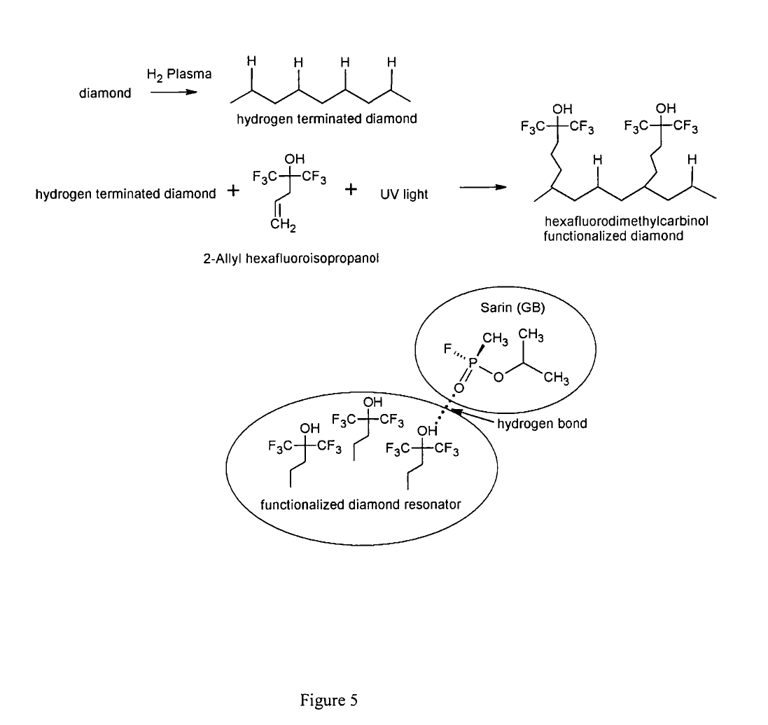

A functionalization scheme to covalently bond sorptive polymers to nanomechanical resonators is shown in FIG. 5. After freely suspending the resonator, the resonators will be coated with a liquid containing a terminal allyl group. In this embodiment, 2-allyl hexafluoroisopropanol was used because it contains the hexafluoro-dimethylcarbinol group shown to be an effective sorbent group for DMMP and DNT.

A quartz mask is then placed on top of the wafer of nanomechanical resonators trapping the liquid between the mask and wafer. A deep UV source, for example Hg arc, Xe arc, or DUV laser, is used to initiate reaction of the terminal allyl with electrons that are generated at the surface of the resonator due to the deep UV exposure. The exposure time is ˜12 hours with a Xe lamp.

After exposure, the wafer of resonators is rinsed in Isopropanol and dried using a critical point dryer (CPD), and characterized using X-ray photoelectron spectroscopy (XPS). XPS shows 50% coverage of a monolayer by this method on diamond and silicon surfaces.

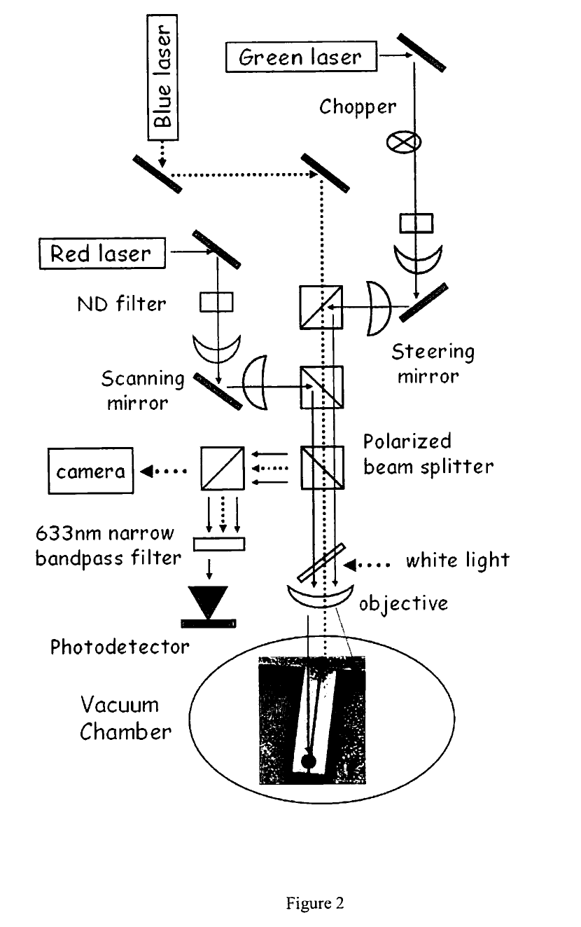

The nanomechanical resonator can be actuated thermally by either a micro-fabricated resistor, or using a modulated heat pulse from a laser. FIG. 2 is a diagram of the optical setup used to measure the response of nanomechanical resonators. In one optical setup, a blue (412 nm diode) laser is modulated using the output of a spectrum analyzer. The modulated blue laser creates a modulated heat pulse that excites the nanomechanical resonator into vibration. The motion is detected optically using a red (633 nm, CW HeNE) laser. The interference between the bottom substrate and the narrow gap of the nanomechanical resonator creates a modulated reflectance, which is detected using a photodiode and the spectrum analyzer. A vacuum chamber allows us to measure the dependence of the quality factor as a function of pressure.

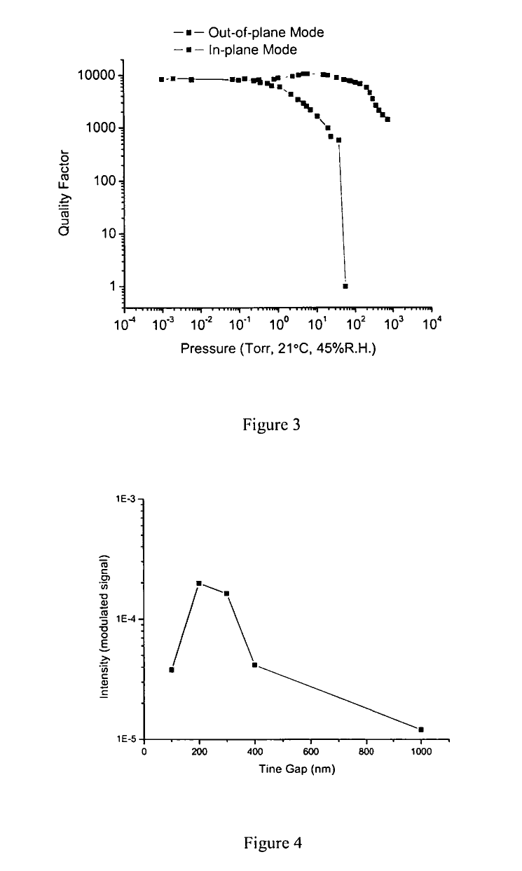

The in-plane modes of vibration show markedly increased quality factors (1000:1) from out-of-plane modes at atmospheric pressure as shown in FIG. 3. Out-of-plane modes of vibration can be used in air at atmospheric pressure to detect an adsorbed mass. The increased sensitivity of in-plane modes with narrow, sub-wavelength gaps is shown in FIG. 4. By varying the gap between the tines of nanomechanical resonator, and measuring the response, a large (five to ten fold) increase in responsivity is noted, which is a key to reaching parts per quadrillion sensitivity.

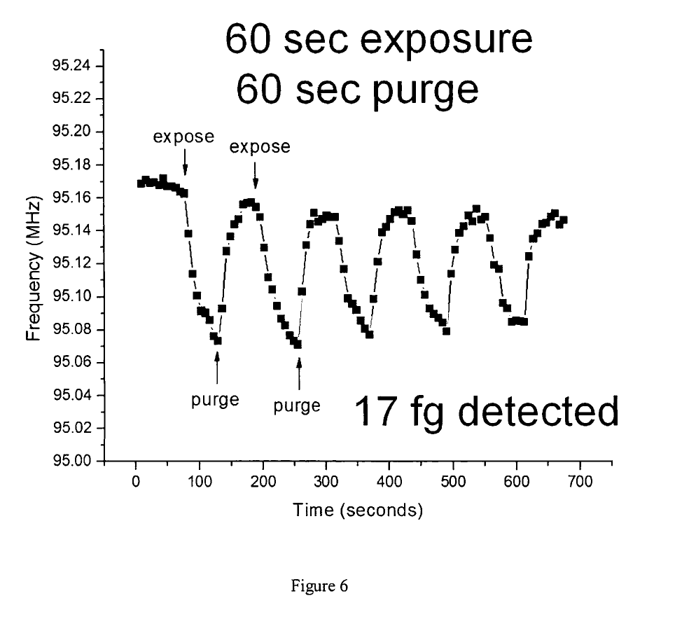

FIG. 6 shows the response of a functionalized nanomechanical resonator in a flow cell upon exposure and purge to an organic base, triethylamine, at a concentration of 70%₀_{_{V}} with a flow rate of 700 ml/min.

A key to this design of this chemical sensor is the use of in-plane vibrations, which give increased sensitivity and low damping for in-air operation (FIG. 3). To measure in-plane vibrations, very narrow gaps (50-300 nm) are incorporated to also increase sensitivity by an order of magnitude.

The ability to pattern using chemical covalent bonds to the resonator gives high quality factors, robustness to the cycling of the device, sensitivity, and selectivity. Each of these ideas has an impact on other fields as well, for example, the narrow gaps can be applied to increase the sensitivity of any optically detected resonator.

Also, the ability to chemically pattern other sensors (e.g. SAW devices, preconcentrators, and chemiresistors) using covalent bonding for attachment to the areas of interest using deep UV light is a much desired technology due to the strong covalent bonding allowing for repeated cycling of the system without degradation.

Combined together these two individually novel ideas create a complete and robust device wherein the sensitivity of the NEMs resonators is increased due to sub-wavelength gaps and wherein the ability exists to chemically functionalize sorbent polymers that are strongly and chemically bound to the NEMS resonator.

### EXAMPLE 2

### Resonator Fabrication and Characterization

A dome-shaped resonator geometry was chosen for this embodiment because of the high surface area available for functionalization which maximizes the ability for analyte detection by adsorption to the resonator's functionalized area. Further, the dome's high rigidity facilitates both functionalization and post-processing.

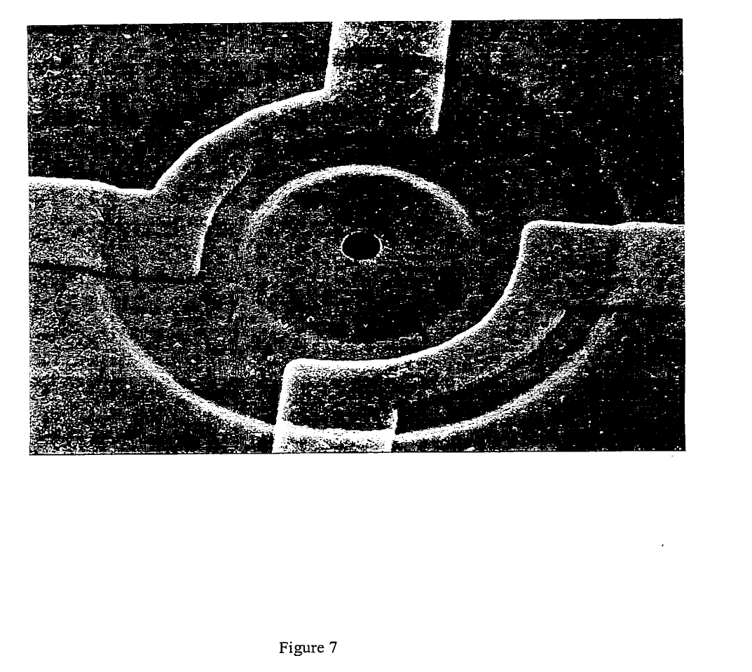

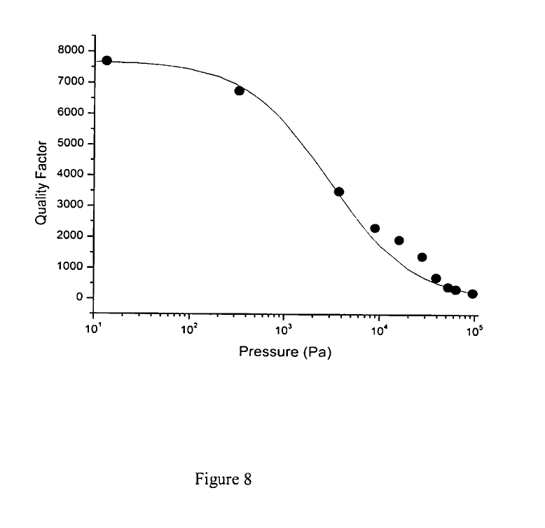

Nanomechanical dome resonators were fabricated from a 320 nm thick gate polysilicon layer of a standard CMOS fabrication process (1.5 μm AMI available through MOSIS). Post-processing release of the dome resonator (FIG. 7) was performed at the Naval Research Laboratory Nanofabrication Facility using a timed etch in BOE (50 min.). Optical transduction was used to study the vibratory response of the resonators from vacuum (˜10⁻⁶ Pa) to atmospheric pressure (FIG. 8). A point-type excitation is provided by modulation of the intensity of a blue diode laser (wavelength 412 nm) focused on the attachment of the resonator to the substrate. The resulting motion was detected interferometrically by focusing another laser (red CW HeNe, 633 nm) at a different point on the resonator and measuring the modulation of the intensity of the reflected light.

Mass sensitivity and Quality Factor

The Quality factor (Q) of a nanomechanical resonator is an important parameter for vibrational-based sensors since their sensitivity is typically directly proportional to Q. The Quality Factor is a measure of the damping in the resonator due to both internal losses (clamping losses, internal friction such as thermoelastic dissipation, and surface effects) and external fluidic energy loss to the surrounding fluid, either through free-molecular momentum transfer or viscous effects. Because external losses can be quite high when the resonator is operated in ambient air, it is important to quantify these losses. Plotting these losses as a function of pressure indicates if the viscous losses should be computed by free-molecular or viscous methods. The quality factor as a function of pressure is shown as FIG. 8.

Because the quality factor is found to be roughly inversely proportional to pressure, it can be concluded that the damping is in the free-molecular flow regime, even at ambient pressure. For systems at low pressures, or nano-systems with extremely small characteristic lengths, the fluid losses can be determined using free-molecular flow models. If the system is operating in a free-molecular flow regime, the quality factor will be inversely proportional to the pressure. The experimental results confirm this, showing that the damping is free-molecular, even at atmospheric pressure. This is consistent with previous experience with nano-scale resonators.

The fluidic quality factor for nano-scale resonators as a function of pressure can be estimated using free-molecular flow theory and is given by:

Q_{f}=ρₛdω/C (1)

where d is the thickness of the membrane, ρₛ is the density of the polysilicon resonator material, and C is the drag per unit area of a cross-section of the dome divided by its velocity. C can be estimated using the linear free-molecular flow theory:

$$C = 3.90 \frac{P}{\sqrt{2 kT / {m}_{g}}} \qquad ( 2 )$$

where P is the pressure, T the temperature, k the Boltzmann constant, and m_{g} the mass of the gas molecules in the system. The fluidic quality factor is then equal to

$${Q}_{f} = 0.256 \frac{{ρ}_{s} d ω}{P} \sqrt{\frac{{m}_{g}}{2 kT}} . \qquad ( 3 )$$

The total quality factor of the resonator is then found by combining the fluidic quality factor with the intrinsic quality factor, Qᵢₙₜ, measured at ultra-high vacuum:

$$Q = \frac{1}{\frac{1}{{Q}_{f}} + \frac{1}{{Q}_{int}}} \qquad ( 4 )$$

The measured Qᵢₙₜ was 7,800. A theoretical estimate of the quality factor is shown in FIG. 8 (trace) as a function of pressure computed using equations (3) and (4), an estimated density for polysilicon of 2331 kg/m³, and a mass per air molecule of 4.81×10⁻²⁶ kg.

The pressure dependence of the quality factor shown in FIG. 8 indicates that the polysilicon film has low internal loss (as inferred for pressures <1000 Pa) and becomes dominated by viscous losses when operated in air. The dome geometry, while it may not be the best shape for use in air, is a good compromise since in air it resonates in its fundamental mode with a quality factor of 300 and in higher order modes with Q's˜two times higher.

Resonator Functionalization

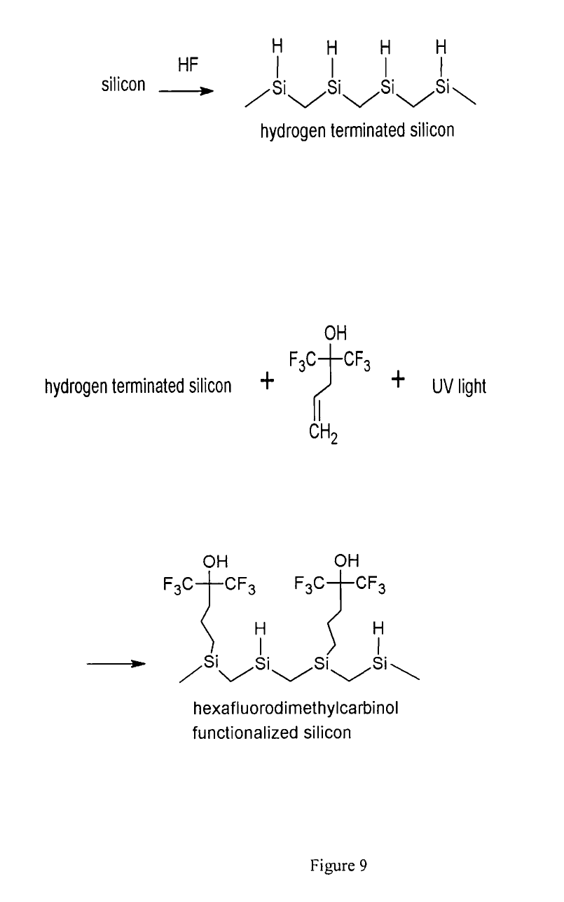

A functionalization technique is outlined in FIG. 9. The starting point for the silicon functionalization scheme is to hydrogen terminate the surface using a quick dip in 50% HF(aq). In order to control the re-oxidation of the silicon surface, it is immediately coated with a drop of 2-allyl hexafluoroisopropanol (SynQuest Laboratories) and covered by a quartz mask. The sample is then exposed using a UV Xe lamp for ˜15 hours. Only the open areas in the quartz mask are exposed to the deep-UV radiation, and thus only those areas are functionalized.

Results

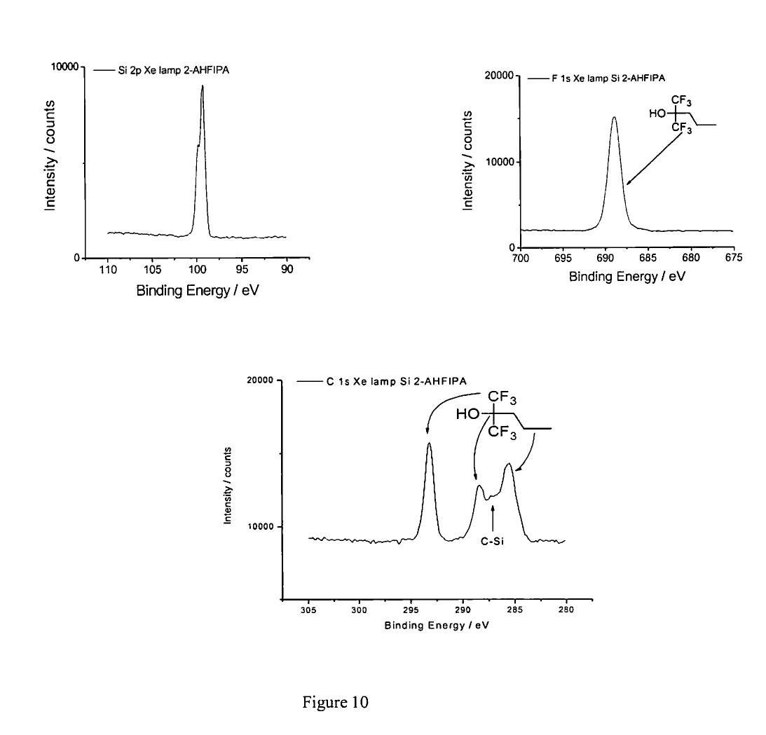

The XPS spectra of the functionalized silicon are shown in FIG. 10. XPS spectra were also taken before functionalization to get a measure of adventitious carbon and oxide formation using the same pre-functionalization techniques (50% HF(aq) for silicon), and to give credence to the fact that this functionalization can be performed in air. Before the XPS data were collected, the quartz mask was removed from the sample. The samples were rinsed in IPA and MEOH and dried at 100° C. on a hotplate for 1 minute.

XPS measurements were performed using a commercial system (Thermo VG Scientific Escalab 220i-XL) equipped with a monochromatic Al Kα source, a hemispherical electron energy analyzer (58° angle between monochromator and analyzer), and a magnetic electron lens. The nominal XPS spot size and analyzer field of view were <1 mm². The binding energies (BEs) are reported with 0.15 eV precision. For the thin organic monolayers in this study, charge compensation was not necessary and was not applied. Data was acquired in normal-emission angle-integrated scans of the C1s,

Si 2p, F 1s, and O 1s regions (15-25 eV windows with 0.15 eV spacing, 30 eV pass energy, 0.36 eV analyzer resolution). Spectra of the various regions were accumulated for 20 scans with a dwell time of 100 msec, to obtain a signal-to-noise ratio adequate for resolving the multiple components. Typically, spectra were acquired from three separate spots on each sample, primarily to test the monolayer uniformity. The corresponding calculated coverage values varied by no more than 10% for each of the samples. The peaks in the elemental core-level spectra were fit using commercial XPS analysis software. Multiple-component fitting in the C 1s region always started from the lowest BE component and its full-core-fwhm's for the higher-BE components. In each case, the minimum number of components that produced unstructured fit residuals was chosen.

The atomic fluorine to carbon ratio was 61% and atomic fluorine to silicon ratio was 45%. XPS being a very surface sensitive technique, these ratios essentially demonstrate that for every silicon atom, there is a carbon atom and fluorine atom present on the surface, which infers that we have greater than 50% of a monolayer coverage on the silicon surface. The C 1s portion of the data also shows chemical shift information which gives concrete evidence for the attachment of hexafluoroisopropanol to the silicon surface. Electronegativity of nearby atoms such as oxygen and fluorine can shift the carbon 1s peak such that the more electronegative the neighboring atom, the further the shift to higher binding energy. The C 1s region was fit using 4 individual peaks for the CF₃ group (293.2 eV), C-OH group (286.8 eV), the C—Si group (288.3 eV), and the CH₂ groups (285.4 eV). The relative area of each group came to be (2.2:1.7:1:2.7) which matches well to the stoichiometry of the molecule (2:1:1:3).

Spectra were also taken after one day and one week to determine how long the monolayer is stable in air. The results of the in-air study show some growth of adventitious carbon on the silicon, but no growth of silicon oxide, suggesting that the substrate is passivated against oxide growth.

### I

This demonstrates the ability to functionalize very thin films of vapor sorbent molecules onto lithographically defined mechanical resonators. Using a photo-induced functionalization scheme allows one to functionalize only the resonator, and not the surrounding area, which would severely decrease sensitivity. Some advantages of monolayer functionalization are: the molecule is chemically bonded to the resonator, thereby opening the potential for better cycling of the device, and the film is thin in comparison to the thickness of the resonator. Thin films (320 nm) of polysilicon have been fabricated using standard CMOS techniques and are shown to be operable in air. The measured pressure dependence determines the mass sensitivity and fits well to computational results. This work demonstrates the ability to create low-cost CMOS MEMS resonators using relatively inexpensive cost-sharing services that make use of multi-project wafers, such as MOSIS, that significantly decrease the cost of each design.

SAW devices, FBAR devices, chemi-resistors, and fluorescent quenching polymers can all be used to detect explosives and chemical agents. However, the extreme sensitivity (˜10⁻¹⁶ g) that can be achieved with NEMS and the low cost of semiconductor fabrication give this technology a real advantage over these other technologies. The minimum detectable mass is projected to be at least an order of magnitude better than the best commercial detection system, and the footprint is orders of magnitude times smaller. This technology could be used in “smart dust” applications where remote monitoring and stealth are essential.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A method of functionalizing a nanomechanical resonator comprising:
providing a wafer with a thin film layer on a sacrificial layer;
suspending freely a resonator on the wafer;
coating the resonator with a liquid containing a terminal allyl group;
placing a quartz-mask on the wafer;
trapping the liquid between the mask and the wafer;
initiating a reaction of the terminal allyl with photo-induced electrons;
rinsing the wafer; and
drying the wafer.

2. The method of claim 1 wherein the liquid is 2-allyl hexafluoroisopropanol.

3. The method of claim 1 wherein the liquid has an effective sorbent group for DMMP or DNT.

4. The method of claim 1 wherein said initiating is performed via a deep UV source.

5. The method of claim 4 wherein said deep UV source is one selected from the group consisting of Hg arc, Xe arc, and DUV laser.

6. The method of claim 4 wherein the electrons of the step of initiating a reaction of the terminal allyl with electrons are electrons that are generated at the surface of the resonator due to the deep UV exposure.

7. The method of claim 1 wherein said step of rinsing comprises using isopropanol.

8. The method of claim 1 wherein said step of drying comprises using a critical point dryer.

9. The method of claim 1 wherein the functionalizing results in about 50% coverage by a monolayer.

10. The method of claim 4 wherein the step via a deep UV source includes about a 12 hour exposure time with a Xe lamp.

11. The method of claim 1 further including incorporating narrow gaps of from about 50 to about 300 nm in the resonator.

12. The method of claim 11 wherein the functionalized nanomechanical resonator has a sensitivity of about 10⁻¹⁶ g.

13. The method of claim 1 wherein the wafer with a thin film layer on a sacrificial layer is one selected from the group consisting of silicon, diamond, polysilicon, and germanium on silicon oxide.

14. A method of functionalizing a nanomechanical resonator comprising:
providing a wafer wherein the wafer is one selected from the group consisting of silicon on silicon oxide, diamond on silicon oxide, polysilicon on silicon oxide, and germanium on silicon oxide;
suspending freely a resonator on the wafer;
coating the resonator with a liquid wherein the liquid contains at least one functional group hexafluoroisopropanol;
placing a quartz-mask on the wafer;
trapping the liquid between the mask and the wafer; and
initiating a reaction of the functional group hexafluoroisopropanol with photo-induced electrons.

15. The method of claim 14 wherein the liquid has an effective sorbent group for DMMP or DNT.

16. The method of claim 15 wherein said initiating is performed via a deep UV source and wherein said deep UV source is one selected from the group consisting of Hg arc, Xe arc, and DUV laser.

17. The method of claim 16 wherein the electrons of the step of initiating a reaction of the functional group hexafluoroisopropanol with electrons are electrons that are generated at the surface of the resonator due to the deep UV exposure.

18. The method of claim 17 wherein the functionalizing results in about 50% coverage by a monolayer.

19. The method of claim 18 further including incorporating narrow gaps of from about 50 to about 300 nm in the resonator.

20. A functionalizing nanomechanical resonator comprising:
a wafer wherein the wafer is one selected from the group consisting of silicon on silicon oxide, diamond on silicon oxide, polysilicon on silicon oxide, and germanium on silicon oxide;
a freely suspended resonator on the wafer;
wherein the resonator is coated with a liquid wherein the liquid contains at least one functional group hexafluoroisopropanol;
wherein the resonator is functionalized by initiating a reaction of the functional group hexafluoroisopropanol with photo-induced electrons and results in about 50% coverage by a monolayer;
wherein the liquid has an effective sorbent group for DMMP or DNT; and
wherein narrow gaps of from about 50 to about 300 nm are incorporated in the resonator.
